(19) United States
(12) Patent Application Publication
(10) Pub. No.: US 2024/0213476 A1
(43) Pub. Date: Jun. 27, 2024

(54) Nano-Cubic Polyanionic Electrode Material, Preparation Method Therefor, And Use Thereof

(71) Applicant: JIANGSU ZENERGY BATTERY TECHNOLOGIES CO., LTD., Suzhou City (CN)

(72) Inventors: Di WANG, Suzhou City (CN); Yingnan DONG, Suzhou City (CN); Jizong ZHANG, Suzhou City (CN); Qiwen JIANG, Suzhou City (CN)

(21) Appl. No.: 18/393,648

(22) Filed: Dec. 21, 2023

(30) Foreign Application Priority Data
Dec. 27, 2022 (CN) 202211680792.2

(51) Int. Cl. H01M 4/60; C01B 25/45; H01M 10/054

(52) U.S. Cl. CPC H01M 4/608; C01B 25/45; H01M 10/054; H01M 2004/021

(57) ABSTRACT

The present disclosure relates to a nano-cubic polyanionic electrode material, a preparation method therefor, and use thereof. The electrode material of the present disclosure comprises NasV₂(PO₄); @M; where M is a block polymer containing disulfide bond; further, a nano-cubic NVP@M@PDA material can be formed by using coupling between PDA and NVP. The conductivity performance and cycle performance of the material obtained in the present disclosure are greatly improved, and the present disclosure well solves the problems associated with matching with a hard carbon negative electrode.

This application claims priority to Chinese Patent Application No. 202211680792.2, filed Dec. 27, 2022, which is incorporated by reference in its entirety herein.

### TECHNICAL FIELD

The present disclosure relates to the technical field of sodium ion batteries, and in particular to a nano-cubic polyanionic electrode material, a preparation method therefor, and use thereof.

### BACKGROUND

Currently, problems such as energy crisis and environmental pollution are becoming more and more serious. Novel rechargeable batteries, represented by alkali metal ion batteries, are gaining national and worldwide attention and application. Among them, lithium batteries are most widely applied, but the price of lithium resource minerals increasingly grow, resulting in shortage of lithium resources. In contrast, batteries made of sodium having abundant reserves on the earth may become the key of future developments. Since the crust reserves of sodium element is abundant, the cost thereof is low. As the sodium ion battery has a similar working mechanism to that of the lithium ion battery, the sodium ion battery will become an excellent alternative to the lithium ion battery in the future.

In the sodium ion battery system, a positive electrode material is a key factor affecting the performance and cost of the battery. Among the currently studied positive electrode materials, the novel NASICON-type vanadium-sodium phosphate material has excellent stability. However, the practical application of directly synthesized vanadium-sodium phosphate positive electrode material is limited due to the electrochemical performance thereof, especially low electrical conductivity, and therefore many research-work pioneers consider how to solve this problem. At present, bulk phase doping based on NVP is mainly to dope a metal element to substitute a part of Na or V, so as to change the volume structure and conductivity of original NVP. Lim et al. ^{[1]} doped potassium ions having a larger ionic radius into an NVP structure, to enlarge the lattice volume of the NVP by extending the c-axis of the NVP, thereby generating a larger sodium ion diffusion path.

Na_{2.91}K_{0.09}V₂(PO₄)₃ has a specific capacity of 110.4 mAh·g⁻¹ at 0.2C, and has obvious improvements in rate and cycle performance compared with un-doped NVP. The method improves the performance of base materials to a certain extent, but has little effect on the conductivity, and still has a large improvement space. Li et al. ^{[2]} obtained a fiber precursor by using an electrospinning method and then performed secondary calcination, to obtain a one-dimensional NVP/C nanorod structure. Using the NVP/C nanorod as a positive electrode of a sodium ion battery generates a specific capacity of 116.9 mAh·g⁻¹ at 0.05C, and has a specific capacity of 105.3 mAh·g⁻¹ at 0.5C. The reason for actual performance improvement has been explored, but the method does not well address the performance defect of the material itself.

### REFERENCES CITED ABOVE

[1] Lim, S. J.; Han, D. W.; Nam, D. H.; Hong, K. S.; Eom, J. Y.; Ryu, W. H.; Kwon, H. S. J. Mater. Chem. A 2014, 2, 19623. doi: 10.1039/C4TA03948C.
[2] Li, H.; Bai, Y.; Wu, F.; Ni, Q.; Wu, C. Solid State Ionics 2015, 278, 281. doi: 10.1016/j.ssi.2015.06.026.

Therefore, how to improve the conductivity and cycle performance of the NASICON-type vanadium-sodium phosphate positive electrode material becomes one of the key problems in the related art of sodium ion batteries.

### SUMMARY

In order to solve the described technical problems, the present disclosure provide a nano-cubic polyanionic electrode material, a preparation method therefor, and use thereof. The electrode material of the present disclosure is Na₃V₂(PO₄)₃@M(NVP@M), which forms a nano-cubic structure by self-assembly of a block polymer containing disulfide bond micelle in an aqueous solution and driving of water evaporation; the nano-cubic structure has a larger contact surface than sphere particles, and can increase the electrical conductivity of the material. Moreover, in the present disclosure, it has been found that PDA is easily coupled with V(III) in NVP; as the structural fragment of the PDA is a conjugate system and contains abundant π electron cloud, the PDA can generate a π-π interaction with other molecules containing a π system, thereby producing a coupling effect; and when the PDA is coupled with the NVP, it is beneficial to facilitate the transmission of sodium ions in the NVP structure and improve the electrochemical performance of the NVP.

The present disclosure is achieved by the following technical solutions:
a first object of the present disclosure is to provide a nano-cubic polyanionic electrode material for a sodium ion battery, where the electrode material comprises Na₃V₂(PO₄)₃@M, and Na₃V₂(PO₄)₃ and M are self-assembled to obtain a nano-cubic structure electrode material; where M is a block polymer containing disulfide bond.

In some embodiments of the present disclosure, the block polymer containing disulfide bond include, but not limited to PLA-SS-PLA, mPEG-SS-PLGA, mPEG-SS-PLA, mPEG-SS-PEI, mPEG-SS-Hyaluronate, mPEG-SS-Dextran, mPEG-SS-Chitosan, PCL-SS-Dextran, PLGA-SS-Dextran, PLA-SS-Dextran, PCL-SS-PEI, PLGA-SS-PEI, PLA-SS-PEI and PTMC-SS-PTMC.

In some embodiments of the present disclosure, the electrode material comprises Na₃V₂(PO₄)₃@M@N, and Na₃V₂(PO₄)₃, M and N are self-assembled to obtain a nano-cubic structure electrode material; where N is dopamine and/or polydopamine.

In some embodiments of the present disclosure, the electrode material has at least one of the following parameters:
a) A lattice spacing of about 1.05 Å to 4.9 Å; a reasonable lattice spacing can ensure smooth movement of sodium ions, and if the spacing is too small (less than 1.05 Å), deintercalation motion of the sodium ions is hindered; and if the spacing is too large (greater than 4.9 Å), the structure easily collapses in a sodium ion circulation process. Therefore, a reasonable lattice spacing can ensure a good electrochemical performance of the battery. The unit Å is called angstrom, and angstrom is a length unit, 1 Å=1×10⁻¹⁰ m.
b) A particle size D50 of 1.5 μm to 115.8 μm; a reasonable particle size is crucial to the process of slurry mixing and sheet preparation of the material, and if the particle size does not belong to this range, an electrode sheet prepared from the material couldn't achieve reasonable performance; if the particle size is too small (less than 1.5 μm), the material is more easily to adsorb side reaction products generated during charging and discharging, thereby deteriorating the cycle performance of an electrochemical energy storage device; and an excessively small average particle size makes it easy to aggregate to form secondary particles, which reduces the compactness of particles of a positive electrode material while increasing the ion diffusion path, making the rate performance of the electrochemical energy storage device poor; and if the average particle size of the material is too large (greater than 115.8 μm), the ion diffusion path is extended, causing a significant decrease in the rate performance of the electrochemical energy storage device.
c) A specific surface area BET of 0.10 m²/g to 2.73 m²/g; a reasonable specific surface area is very critical to the material performance. If the specific surface area of the material is too large (greater than 2.73 m²/g), the material has a relatively strong adsorption capacity, and side reaction products generated by the electrochemical energy storage device during charging and discharging are easily enriched on the surface of the positive electrode material to undergo a further oxidation reaction; and then the generated product will cover the surface of the positive electrode material, the polarization of the positive electrode is increased, a part of the positive electrode material is deactivated, causing energy loss of the positive electrode material, so that the capacity of the electrochemical energy storage device is attenuated quickly and the cycle performance is reduced quickly; and if the specific surface area of the material is too small (less than 0.10 m²/g), the ion diffusion path is extended, and the rate performance of the electrochemical energy storage device will decrease; in addition, if the specific surface area is too small, the contact area between the material and an electrolyte is relatively small, resulting in an increase in electron transfer impedance, which is manifested as a relatively large internal resistance of the electrochemical energy storage device, and also significant reduction of the cycle performance.
d) A water content of 0.001 wt % to 3.56 wt %; if the water content is too high, an electrode sheet prepared by the material has risks of powder shedding, and a safety risk during a battery cycle.

A second object of the present disclosure is to provide a preparation method for a nano-cubic polyanionic electrode material for a sodium ion battery, comprising the following steps:
(1) mix a vanadium source, a sodium source and a phosphorus source uniformly, add a block polymer M containing disulfide bond, dissolve in a solvent, and stir to obtain a gel; and
(2) drip the gel obtained in step (1) onto the surface of a solid substrate, and perform a rotary heating under irradiation of an external light source and protection of a reducing gas, so as to obtain the nano-cubic polyanionic electrode material for a sodium ion battery.

Mechanisms of the preparation method for an electrode material of the present disclosure are: (1) spherical micelles are formed by dispersing a block polymer in water, and as the water content decreases gradually, the micelle concentration increases, micelle molecules are gathered together gradually and form a face-centered cubic crystal; and in this process, NVP is attached to and integrally formed with the block polymer colloid. As shown in FIG. 6, finally, when the water is completely evaporated, a cubic crystal of Na₃V₂(PO₄)₃@M with a side length of about 100 nanometers is obtained by crystallization. (2) A certain amount of weak centrifugal force can be increased by rotary heating, so as to enhance the agglomeration force between micelles during evaporation of water. (3) The purpose of using an external light source for irradiation is to cross-link, by photo-initiation, disulfide bonds between micelle molecules constituting a crystal, so that a crystal structure formed is locked and is difficult to be dissolved by water. (4) A reducing gas is used to form V³⁺ in the vanadium-sodium phosphate material.

In some embodiments of the present disclosure, step (1) further includes adding a dopamine solution and/or a polydopamine solution.

In some embodiments of the present disclosure, the dopamine solution is prepared by the following method: add polydopamine or dopamine hydrochloride (DAH) to water and hydrochloric acid (37 wt %), and mix uniformly to prepare a polydopamine solution or a dopamine solution.

In some embodiments of the present disclosure, the concentration of the dopamine solution or the polydopamine solution is 5 wt % to 15 wt %.

In some embodiments of the present disclosure, in step (1), the vanadium source includes, but not limited to vanadium pentoxide, vanadium trioxide, ammonium metavanadate, vanadium phosphate monohydrate, vanadium sulfate and vanadyl sulfate monohydrate.

In some embodiments of the present disclosure, in step (1), the sodium source includes, but not limited to sodium carbonate, sodium hydroxide, sodium oxide, sodium peroxide, sodium phosphate, sodium sulfate, sodium dihydrogen phosphate, sodium dihydrogen sulfate, and sodium phenoxide.

In some embodiments of the present disclosure, in step (1), the phosphorus source includes, but not limited to phosphate, phosphoric acid and phosphorus pentoxide.

In some embodiments of the present disclosure, the phosphate includes, but not limited to ammonium dihydrogen phosphate, sodium dihydrogen phosphate, diammonium hydrogen phosphate, and disodium hydrogen phosphate.

In some embodiments of the present disclosure, in step (1), the block polymer containing disulfide bond includes, but not limited to PLA-SS-PLA, mPEG-SS-PLGA, mPEG-SS-PLA, mPEG-SS-PEI, mPEG-SS-Hyaluronate, mPEG-SS-Dextran, mPEG-SS-Chitosan, PCL-SS-Dextran, PLGA-SS-Dextran, PLA-SS-Dextran, PCL-SS-PEI, PLGA-SS-PEI, PLA-SS-PEI and PTMC-SS-PTMC.

In some embodiments of the present disclosure, in step (1), the molar ratio of the vanadium source, the sodium source, and the phosphorus source is 0.01-2:0.01-4:0.01-3.

In some embodiments of the present disclosure, in step (1), the solvent includes, but not limited to ethanol, water, acetone, methanol, toluene, pentane, ethyl acetate and diethyl ether.

Preferably, the solvent is a mixed solvent of ethanol and water, and a volume ratio of the ethanol to the water is 0.01-500:0.01-500.

In some embodiments of the present disclosure, in step (2), the material of the solid substrate is selected from aluminum, copper, silicon or glass.

In some embodiments of the present disclosure, in step (2), conditions of the rotary heating includes: a rotational speed is 0.1 rpm to 100 rpm, a temperature is 250° C. to 1050° C., and a time is 0.5 h to 48 h; and conditions of the irradiation by an external light source are 10 nm to 1050 nm; the illumination intensity is 80 w/cm² to 240 w/cm², and the time is 0.5 h to 3 h.

Preferably, the external light source is visible light or invisible light.

Preferably, the rotary heating is first performed at a low temperature of 70° C. to 100° C. for 0.25 h to 0.5 h, then the solid substrate is removed, and heating and sintering are continued.

Further, the low-temperature heating temperature is 70° C. to 80° C., 80° C. to 90° C. and 90° C. to 100° C. Specifically, 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., etc., or any numerical value between these numerical values.

In some embodiments of the present disclosure, in step (2), the reducing gas at least satisfies one of the following conditions:
a) the reducing gas includes hydrogen and an inert gas or nitrogen; the inert gas is selected from at least one of helium (He) gas, neon (Ne) gas, and argon (Ar) gas;
b) a volume percentage of hydrogen H₂ is greater than 0% and less than or equal to 20%, and a volume percentage of the inert gas is greater than or equal to 80% and less than 100%.

A third object of the present disclosure is to provide an electrode sheet, which includes the nano-cubic polyanionic electrode material for a sodium ion battery or a nano-cubic polyanionic electrode material for a sodium ion battery obtained by the preparation method.

A fourth object of the present disclosure is to provide a sodium battery, which includes the electrode sheet.

Compared with the related art, the technical solutions of the present disclosure have the following advantages:

The present disclosure provides a novel nano-cubic vanadium-sodium phosphate positive electrode material for a sodium ion battery, which greatly improves the electrical conductivity, gram capacity, rate performance and cycle performance of the material, and well solves the problems associated with matching with a hard carbon negative electrode.

The present disclosure proposes a simple method of forming nanocrystals by self-polymerization of a block polymer containing disulfide bond and driving by water evaporation, which has good practical significance of application. Polymerization of a block polymer containing disulfide bond gel by photo-initiation to form a cubic crystal loading a vanadium-sodium phosphate positive electrode material increases the contact interface between particles, and can directly improve the electrical conductivity, thereby facilitating improvement of rate performance. Furthermore, by introducing dopamine (DA) or polydopamine (PDA) to couple with NVP, the transmission of sodium ions in the NVP structure is facilitated, and the rate performance and cycle performance of the material can be significantly improved. FIG. 7 is an in situ Raman spectrum of the material of Example 2 of the present disclosure, and it can be obtained that during charging and discharging, V³⁺ is oxidized to V⁵⁺ and then reduced to V³⁺, which indicates that the positive electrode material prepared in the present disclosure has good structural stability. A specific coupling model is as shown in FIG. 8, and it can be determined from FIG. 8 that a PDA has a certain spin density; this spin force couples V(III), and causes the position of V(III) to move; therefore, the lattice space is expanded, achieving the purpose of facilitating the transmission of sodium ions in the NVP, and improving the specific capacity, rate performance and cycle performance.

The simple water-solvent evaporation-driven self-assembly and synthesis technology proposed by the present disclosure provides new insights for optimized design of the structure of NVP-type materials, and has a very broad application prospect.

### BRIEF DESCRIPTION OF THE DRAWINGS

In order to make the content of the present disclosure more easily and clearly understood, the present disclosure will be further described in detail below according to specific embodiments of the present disclosure in conjunction with the accompanying drawings, in which:

FIG. 1 is a scanning electron microscope (SEM) graph of an NVP@PTMC-SS-PTMC positive electrode material according to Example 1 of the present disclosure; where a is an SEM graph of the positive electrode material at a low magnification, and b is an SEM graph of the positive electrode material at a high magnification;

FIG. 2 is a transmission electron microscope (TEM) graph of an NVP@PTMC-SS-PTMC positive electrode material according to Example 1 of the present disclosure;

FIG. 3 is a scanning electron microscope (SEM) graph of an NVP@PTMC-SS-PTMC@PDA positive electrode material according to Example 2 of the present disclosure; where a is an SEM graph of the positive electrode material at a low magnification, and b is an SEM graph of the positive electrode material at a high magnification;

FIG. 4 is a transmission electron microscope (TEM) graph and a Mapping graph of an NVP@PTMC-SS-PTMC@PDA positive electrode material according to Example 2 of the present disclosure;

FIG. 5 is an XRD graph of the NVP@PTMC-SS-PTMC positive electrode material in Example 1 of the present disclosure;

FIG. 6 is a diagram showing the mechanism of forming nanocubes in the present disclosure;

FIG. 7 is an in-situ Raman spectrum of the NVP@PTMC-SS-PTMC@PDA positive electrode material according to Example 2 of the present disclosure; and

FIG. 8 is a PDA simulation diagram of the NVP@PTMC-SS-PTMC@PDA positive electrode material according to Example 2 of the present disclosure; where a is a PDA simulation diagram of the NVP@PTMC-SS-PTMC@PDA positive electrode material; b is the spin density of the PDA; c is PDA being coupled with one V(III) of NVP; and d is PDA being coupled with two V(III) of NVP.

### DETAILED DESCRIPTION OF THE EMBODIMENTS

Hereinafter, the present disclosure will be further described with reference to the accompanying drawings and specific embodiments, so that a person skilled in the art could better understand the present disclosure and implement same, but the embodiments listed are not intended to limit the present disclosure.

It is contemplated that the claimed composition, mixture, system, method and process of the present disclosure include variations and adaptations using information derived from the embodiments described herein. Adaptations and/or variations of the composition, mixture, system, method and process described in the present disclosure may be made by a person of ordinary skill in the art.

It should be understood that the sequence of steps or the sequence in which particular acts are performed is inessential, as long as the present disclosure remains operational. Furthermore, two or more step behaviors may be performed simultaneously.

### I. A Preparation Method for a Material:

(1) A method (100) for preparing a composition NVP@M is as follows:
(110) uniformly mixed, at a ratio, (0.01 mol to 2 mol) of a pentavalent vanadium source (vanadium pentoxide, vanadium trioxide, ammonium metavanadate, vanadium phosphate monohydrate, vanadium sulfate and vanadyl sulfate monohydrate, etc.), (0.01 mol to 4 mol) of a sodium source (sodium carbonate, sodium hydroxide, sodium oxide, sodium peroxide, sodium phosphate, sodium sulfate, sodium dihydrogen phosphate, sodium dihydrogen sulfate, and sodium phenoxide, etc.) and (0.01 mol to 3 mol) of a phosphorus source (ammonium dihydrogen phosphate, sodium dihydrogen phosphate, diammonium hydrogen phosphate, disodium hydrogen phosphate, phosphoric acid, phosphorus pentoxide, etc.), added a certain amount (0.01 g to 10 g) of a block polymer containing disulfide bond M, and dissolved in a mixture of ethanol (0.01 mL to 500 mL) and deionized water (0.01 mL to 500 mL);
(120) stirred the described solution (at a speed of 10 rpm to 100 rpm; the time is 0.5 h to 6 h) and generating a physical gel, to form a gel solution;
(130) dripped the gel solution onto a solid surface (aluminium, copper, silicon, glass, etc.), evaporated water by using a rotary heating method at a certain rate and temperature, to prepared a material; and
(140) the specific measures were: transferred the described solid substrate loaded with the gel solution into a rotary heating furnace, the rotational speed was 0.1 rpm to 100 rpm, the temperature was 250° C. to 1050° C. and the time was 0.5 hour to 48 hours. Moreover, the material preparation region is irradiated with an external light source and protected by a reducing gas throughout the whole process.

(2) A method (200) for preparing a composition NVP@M@PDA is as follows:
(210) uniformly mixed, at a ratio, (0.01 mol to 2 mol) of a pentavalent vanadium source (vanadium pentoxide, vanadium trioxide, ammonium metavanadate, vanadium phosphate monohydrate, vanadium sulfate and vanadyl sulfate monohydrate, etc.), (0.01 mol to 4 mol) of a sodium source (sodium carbonate, sodium hydroxide, sodium oxide, sodium peroxide, sodium phosphate, sodium sulfate, sodium dihydrogen phosphate, sodium dihydrogen sulfate, and sodium phenoxide, etc.) and (0.01 mol to 3 mol) of a phosphorus source (ammonium dihydrogen phosphate, sodium dihydrogen phosphate, diammonium hydrogen phosphate, disodium hydrogen phosphate, phosphoric acid, phosphorus pentoxide, etc.), added a certain amount (0.01 g to 10 g) of a block polymer containing disulfide bond M and PDA, and dissolved in a mixture of ethanol (0.01 mL to 500 mL) and deionized water (0.01 mL to 500 mL);
(220) to (240) are consistent with (120) to (140).

In particular embodiments, the composition is used as an electrode material in electrochemical devices such as sodium batteries. In preferred embodiments, the electrode material is a positive electrode material.

### II. Performance Test Method for the Material:

1. XRD Test Method:

In the present disclosure, XRD (diffraction of x-rays) is used to detect the material: a prepared powder material is ground, then transferred to a glass slide, and transferred to an X-ray diffractometer for a scanning test, wherein the scanning range is 10° to 80°, and the scanning speed is 5°/min.

2. Raman Test Method:

In the present disclosure, an in-situ Raman spectrum tester is used to test a Raman spectrum: the material is ground into a powder and transferred to a glass slide, and then the glass slide is transferred to an in-situ Raman diffraction tester to test the Raman spectrum.

3. SEM Sample Preparation and Test Method:

In the present disclosure, a new-generation TESCAN MAGNA ultra-high-resolution field-emission scanning electron microscope is used to test a scanning electron microscope graph: the material is ground into a powder, a part of the material is attached and adhered to a glass slide by using a conductive adhesive, then the glass slide is put in the electron microscope, for testing a scanning electron microscope graph.

4. TEM Sample Preparation and Test Method:

In the present disclosure, a JEOL JEM-2800 high-throughput field-emission transmission electron microscope is used to test a transmission electron microscope graph and a Mapping graph: the material is ground into a powder and a small amount of the powder is added into alcohol and dispersed; an supernatant liquid is taken and dripped on an ultra-thin carbon film slide, then the slide is placed in a sample holder, the tube is placed in a vacuum chamber; after vacuumizing for 30 minutes, SEM testing is started; and then a face-scanning manner is used to test a Mapping graph of the material.

### III. Assembly of a Laminated Pouch Battery and Electrochemical Performance Test Process are as Follows:

mixed the positive electrode material obtained in the present disclosure: conductive carbon: PVDF at a mass ratio of 90:5:5, dissolved in a certain amount of NMP, stirred, coated, dryed, and sliced; likewise, weighed a negative electrode hard carbon material: conductive carbon: CMC/SBR at a mass ratio of 90:5:5, dissolved in a certain amount of water, stirred, coated, dryed, and sliced. A lamination process was used for electrode sheets, a separator was first for forming a sheet and wound for ⅔ turns, then a cathode, the separator and an anode are laminated in order, 10 sheets are laminated in total, and finally after lamination of the anode was ended, the separator was laminated for 2 turns again, so as to ensure that the cathode sheet was completely wrapped by the anode. A prepared jelly roll was welded with tabs and was adhered with an adhesive tape, then the jelly roll was sealed with an aluminum plastic film (pouch forming according to a specification), was baked in a vacuum oven for 10 h to 120 h and then was taken out to test the water content (which requires H₂O<200 ppm), and then injected electrolyte according to a certain liquid injection coefficient and ratio, sealed, aged, performed formation and capacity grading test. An electrolyte used was 1M sodium hexafluorophosphate dissolved in a solvent having a volume ratio of EC: DEC=1:1. After standing for 8 hours on a LAND standard testing machine, an assembled battery starts a test step, adopted charging and discharging at a rate of 1C, and a theoretical specific capacity was 118 mAh/g (the capacity was designed according to a pre-calculated capacity). A current of 1C was used for first charging and then discharging, and finally a corresponding capacity value can be read and calculated. The steps of rate performance test in the present disclosure were as follows: mounting the assembled new battery on a battery cabinet, input a rate test program in a computer, and read corresponding performance.

### Experiment Examples

### Example 1

1. Embodiments of the present disclosure provided a method for preparing an NVP@PTMC-SS-PTMC material, specifically as follows:
(1) ammonium metavanadate and sodium dihydrogen phosphate at a molar ratio of 2:3 were placed into a container; 50 mL of deionized water and 50 mL of ethanol solution were added, and 10 mg of PTMC-SS-PTMC was added, so as to obtain a mixture;
(2) the mixture obtained in step (1) was stirred at a rotational speed of 50 rpm for 3 hours to form a colloid solution;
and (3) the colloid solution of step (2) was dripped onto an aluminum foil (13 μm) and was transferred to a rotary heating furnace, and under the protection of mixed gas of hydrogen gas and argon gas with a volume ratio of 5%:95% in the furnace, a heating region was irradiated with ultraviolet light, where the heating and temperature-rising rate was 5° C./min, the rotational speed of the rotary heating furnace was 30 rpm, and the mixture was heated at 325° C. and 925° C. for 0.5 h and 6.5 h respectively, where after a sintering step at 325° C., the aluminum foil was removed, and then the mixture was continuously heated to obtain the NVP@PTMC-SS-PTMC material. Relevant parameters of the obtained material were tested, to obtain a particle size D50=5.67 μm of the material; a specific surface area BET=1.57 m²/g; and a water content of 0.85 wt %.

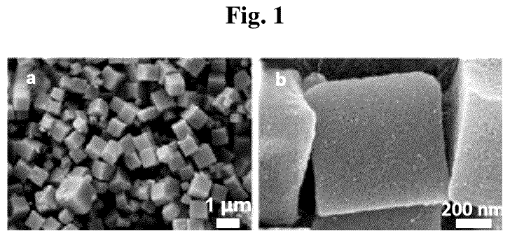

2. Structural characterization was performed on the obtained NVP@PTMC-SS-PTMC material, and the experimental results are as shown in FIGS. 1, 2 and 5.

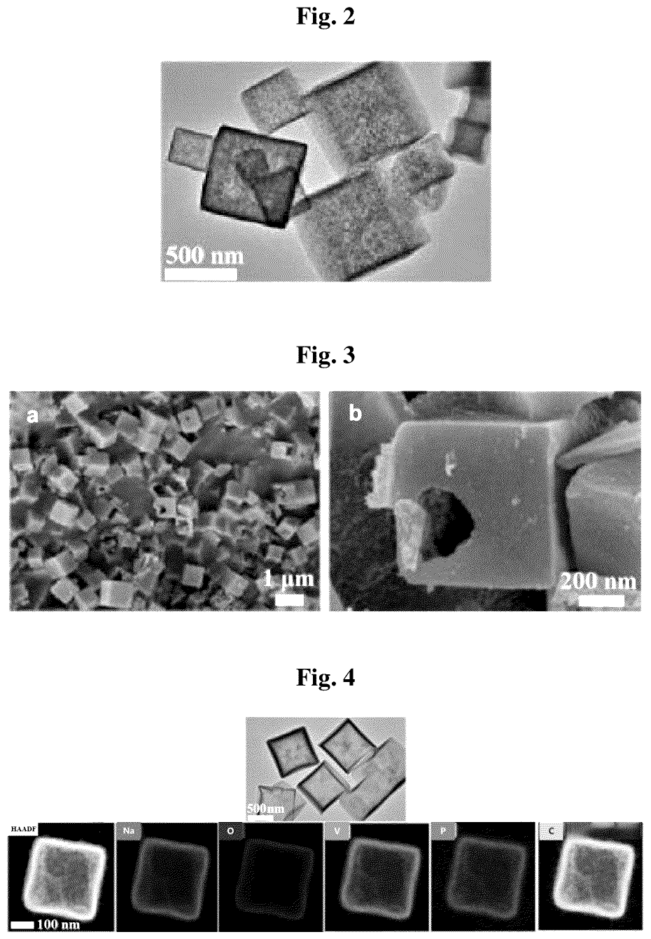

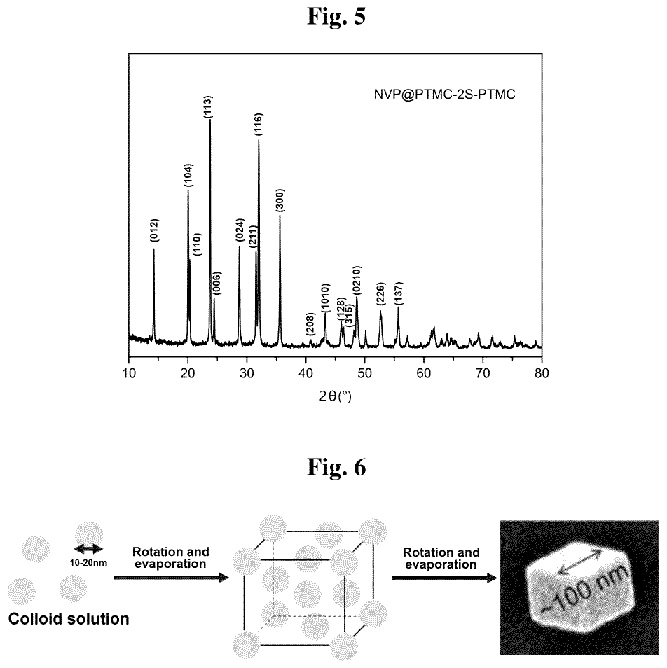

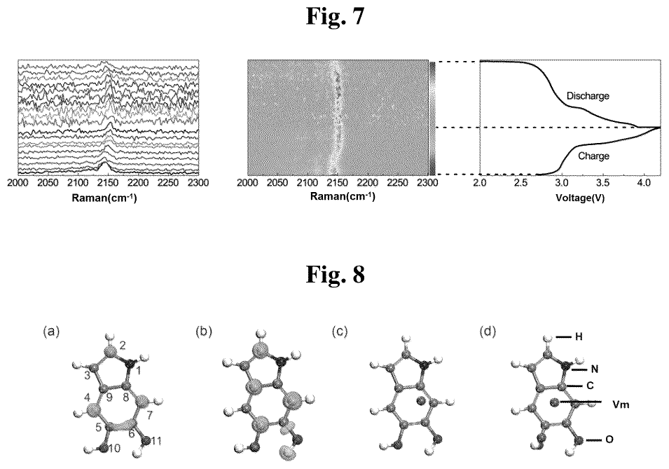

FIG. 1 is a scanning electron microscope graph of the material, where the material has an obvious cubic morphology; FIG. 2 is a TEM graph of the material, also exhibiting a nano-cubic morphology, which indicates that the prepared material is indeed a nano-cubic morphology. FIG. 5 is an XRD graph of the material; it can be determined from the figure that the curve has an upward warping tendency at an interval of 10° C. to 20° C., which further illustrates that the material contains a disulfide bond; and also other displayed peaks are consistent with a standard vanadium-sodium phosphate card, it indicates that the material is indeed an NVP material.

3. Perform battery performance tests on the obtained NVP@PTMC-SS-PTMC material.

An NVP@PTMC-SS-PTMC material as a positive material, a hard carbon material as a negative material, and a standard electrolyte prepared by dissolving 1M sodium hexafluorophosphate in a mixed solvent of EC and DEC at a volume ratio of 1:1 were used to conduct an experiment on a button battery, the battery was tested at a current density of 1C, and the experiment results are as shown in Table 1. It can be determined from Table 1 that an initial specific capacity of about 107.5 mAh/g is achieved in a voltage range of 2V to 4V; after 100 cycles, the capacity is 100.3 mAh/g; the capacity retention rate is up to 93.3%; and the gram capacities at rates of 5C, 10C and 20C are 102.5 mAh/g, 95.4 mAh/g and 86.8 mAh/g respectively, which all have higher specific capacity, rate performance and cycle performance.

### Example 2

1. Embodiments of the present disclosure provided a method for preparing an NVP@PTMC-SS-PTMC@PDA material, specifically as follows:
(1) precursors, ammonium metavanadate and sodium dihydrogen phosphate at a molar ratio of 2:3 were placed into a container; 50 mL of deionized water and 50 mL of ethanol solution were added, and 10 mg of PTMC-S-S-PTMC and 5 mg of PDA were added; other steps were the same as those in Example 1.

2. Structural characterization was performed on the obtained NVP@PTMC-SS-PTMC@PDA material, and the experimental results are as shown in FIGS. 3 and 4.

FIG. 3 is an SEM graph of the material, where the material has an obvious cubic morphology. Compared with Example 1, the surface of the material has a smooth and particle-free feeling, indicating that PDA is wrapped on the surface of the material. FIG. 4 shows a TEM graph of the material, where the material has a smooth nano-cubic structure, and it can be obtained from the Mapping graph that the material is indeed an NVP@PTMC-SS-PTMC@PDA material.

3. Perform battery performance tests on the obtained NVP@PTMC-SS-PTMC@PDA material.

An NVP@PTMC-SS-PTMC@PDA material as a positive material, a hard carbon material as a negative material, and a standard electrolyte prepared by dissolving 1M sodium hexafluorophosphate in a mixed solvent of EC and DEC at a volume ratio of 1:1 were used to conduct an experiment on a laminated pouch battery. The battery was tested at a current density of 1C, and the experiment results are as shown in Table 1. It can be determined from Table 1 that an initial specific capacity of about 117.6 mAh/g is achieved in a voltage range of 2V to 4V; after 100 cycles, the capacity is 113.5 mAh/g; the capacity retention rate is up to 96.5%; and the gram capacities at rates of 5C, 10C and 20C are 110.8 mAh/g, 105.6 mAh/g and 100.21 mAh/g respectively. Compared with Example 1, the coupling effect of PDA and NVP was introduced, facilitating the transmission of sodium ions in the NVP structure. Thus, the rate performance and the cycle performance are improved.

### Comparative Example 1

1. Comparative examples of the present disclosure provided a method for preparing an NVP material, specifically as follows:
(1) ammonium metavanadate and sodium dihydrogen phosphate at a molar ratio of 2:3 were placed into a container; 50 mL of deionized water and 50 mL of ethanol solution were added; other steps were the same as those in Example 1.

2. Perform battery performance tests on the obtained NVP material.

At a current density of 1C, an NVP material as a positive electrode, a hard carbon material as a negative electrode, and a standard electrolyte prepared by dissolving 1M sodium hexafluorophosphate in a mixed solvent of EC and DEC at a volume ratio of 1:1 were used to conduct an experiment on a laminated pouch battery. The battery was tested at a current density of 1C, and the experiment results are as shown in Table 1. It can be determined from Table 1 that an initial specific capacity of about 90.6 mAh/g is achieved in a voltage range of 2V to 4V; after 100 cycles, the capacity is 77.4 mAh/g; the capacity retention rate is only 85.4%. Compared with Examples 1 and 2, without the addition of PTMC-S-S-PTMC and PDA, a nano-cubic structure is not formed, and the material has poor performance.

### Comparative Example 2

1. Comparative examples of the present disclosure provided a method for preparing an NVP@PDA material, specifically as follows:
(1) ammonium metavanadate and sodium dihydrogen phosphate at a molar ratio of 2:3 were added into a container; 50 mL of deionized water and 50 mL of ethanol solution were added, and 5 mg of PDA was added; other steps were the same as those in Example 1.

2. Perform battery performance tests on the obtained NVP@PDA material.

At a current density of 1C, an NVP@PDA material as a positive material, a hard carbon material as a negative material, and a standard electrolyte prepared by dissolving 1M sodium hexafluorophosphate in a mixed solvent of EC and DEC at a volume ratio of 1:1 were used to conduct an experiment on a laminated pouch battery. The battery was tested at a current density of 1C, and the experiment results are as shown in Table 1. It can be determined from Table 1 that an initial specific capacity of about 100.4 mAh/g is achieved in a voltage range of 2V to 4V; after 100 cycles, the capacity is 89.2 mAh/g; the capacity retention rate is only 88.8%. Compared with Examples 1 and 2, by merely adding PDA, a nano-cubic structure is not formed; although the performance of the material is improved due to benefit from the coupling effect of the PDA and the NVP, the performance of the material is not good compared with Example 2.

### Example 3. Preparation of Material NVP@PLA-SS-PLA

The preparation method was the same as that in Example 1, only PLA-SS-PLA was used to replace the PTMC-SS-PTMC; the obtained material was used to prepare an electrode sheet and a battery was assembled, and the performance thereof was tested, and the results are shown in Table 1.

### Example 4. Preparation of Material NVP@PLA-SS-PLA@PDA

The preparation method was the same as that in Example 2, only PLA-SS-PLA was used to replace the PTMC-SS-PTMC; the obtained material was used to prepare an electrode sheet and a battery was assembled, and the performance thereof was tested, and the results are shown in Table 1.

### Example 5. Preparation of Material NVP@mPEG-SS-PLGA@PDA

The preparation method was the same as that in Example 2, only mPEG-SS-PLGA was used to replace the PTMC-SS-PTMC; the obtained material was used to prepare an electrode sheet and a battery was assembled, and the performance thereof was tested, and the results are shown in Table 1.

### Example 6. Preparation of Material NVP@mPEG-SS-PEI@PDA

The preparation method was the same as that in Example 2, only mPEG-SS-PEI was used to replace the PTMC-SS-PTMC; the obtained material was used to prepare an electrode sheet and a battery was assembled, and the performance thereof was tested, and the results are shown in Table 1.

### Example 7. Preparation of Material NVP@PCL-SS-PEI@PDA

The preparation method was the same as that in Example 2, only PCL-SS-PEI was used to replace the PTMC-SS-PTMC; the obtained material was used to prepare an electrode sheet and a battery was assembled, and the performance thereof was tested, and the results are shown in Table 1.

### Example 8. Preparation of Material NVP@PLA-SS-PEI@PDA

The preparation method was the same as that in Example 2, only PLA-SS-PEI was used to replace the PTMC-SS-PTMC; the obtained material was used to prepare an electrode sheet and a battery was assembled, and the performance thereof was tested, and the results are shown in Table 1.

### Example 9. Preparation of Material NVP@PCL-SS-Dextran@PDA

The preparation method was the same as that in Example 2, only PCL-SS-Dextran was used to replace the PTMC-SS-PTMC; the obtained material was used to prepare an electrode sheet and a battery was assembled, and the performance thereof was tested, and the results are shown in Table 1.

### Example 10. Preparation of Material NVP@PLGA-SS-Dextran@PDA

The preparation method was the same as that in Example 2, only PLGA-SS-Dextran was used to replace the PTMC-SS-PTMC; the obtained material was used to prepare an electrode sheet and a battery was assembled, and the performance thereof was tested, and the results are shown in Table 1.

### Example 11. Preparation of Material NVP@PLA-SS-Dextran@PDA

The preparation method was the same as that in Example 2, only PLA-SS-Dextran was used to replace the PTMC-SS-PTMC; the obtained material was used to prepare an electrode sheet and a battery was assembled, and the performance thereof was tested, and the results are shown in Table 1.

### Experimental Comparative Example

Compared with the Examples, a similar material preparation method is used, for preparing corresponding Examples 1 to 11 and Comparative Examples 1 to 2 by adjusting the types and ratios of different doped materials; and after a large-scale test, the performance of assembled sodium ion batteries thereof is as shown in the following table.

TABLE 1
Main parameters and sodium ion battery performance of Examples 1 to 11 and Comparative Examples 1 to 2

| | | Discharge specific | | | Remaining | Capacity |
|---|---|---|---|---|---|---|
| | | capacity at a | Initial | Rate | capacity | retention |
| | | current density | Coulombic | performance | after 100 | rate after |
| | | of 1 C | efficiency | at 5/10/20 C | cycles | 100 cycles |
| Example | Molecular formula | (mAh/g) | (%) | (mAh/g) | (mAh/g) | (%) |
| Example1 | NVP@PTMC-SS-PTMC | 107.5 | 85.3 | 102.5/95.4/86.8 | 98.04 | 91.2 |
| Example 2 | NVP@PTMC-SS-PTMC@PDA | 117.6 | 88.9 | 110.8/105.6/100.21 | 113.5 | 96.5 |
| Comparative | NVP | 90.6 | 79.4 | 85.4/77.32/68.6 | 77.4 | 85.4 |
| Example 1 | | | | | | |
| Comparative | NVP@PDA | 100.4 | 81.5 | 94.8/88.6/73.2 | 89.2 | 88.8 |
| Example 2 | | | | | | |
| Example 3 | NVP@PLA-SS-PLA | 105.8 | 83.5 | 100.4/94.3/84.5 | 95.4 | 90.2 |
| Example 4 | NVP@PLA-SS-PLA@ | 109.2 | 85.6 | 104.2/96.4/89.9 | 100.4 | 91.9 |
| | PDA | | | | | |
| Example 5 | NVP@mPEG-SS-PLGA@PDA | 110.4 | 85.7 | 105.2/97.7/89.8 | 101.5 | 92.0 |
| Example 6 | NVP@mPEG-SS-PEI@ | 111.5 | 86.4 | 106.6/99.5/90.2 | 102.5 | 92.1 |
| | PDA | | | | | |
| Example 7 | NVP@PCL-SS-PEI@PDA | 108.4 | 82.5 | 100.3/92.5/88.54 | 99.1 | 91.4 |
| Example 8 | NVP@PLA-SS-PEI@PDA | 109.6 | 85.4 | 103.2/96.5/88.4 | 100.3 | 91.5 |
| Example 9 | NVP@PCL-SS-Dextran | 110.5 | 86.2 | 104.6/97.3/89.2 | 103.3 | 93.5 |
| | @PDA | | | | | |
| Example 10 | NVP@PLGA-SS-Dextran@PDA | 111.4 | 86.4 | 106.5/99.4/90.0 | 102.5 | 92.0 |
| Example 11 | NVP@PLA-SS-Dextran | 110.3 | 86.0 | 104.3/97.1/88.9 | 102.5 | 92.9 |
| | @PDA | | | | | |

It can be determined from Table 1:

1. Compared with Comparative Example 1, Example 1 has the following advantages: (1) the discharge specific capacity is increased by 18.7%; (2) the initial coulombic efficiency is increased by 7.4%; (3) the rate performance also exhibits the advantage of significant increase; (4) after 100 cycles, the remaining capacity is increased by 26.7%; and (5) the capacity retention rate after 100 cycles is increased by 6.8%. Compared with Comparative Example 2, Example 2 has the following advantages: (1) the discharge specific capacity is increased by 17.13%; (2) the initial coulombic efficiency is increased by 9.1%; (3) the rate performance also exhibits the advantage of significant increase; (4) after 100 cycles, the remaining capacity is increased by 27.2%; and (5) the capacity retention rate after 100 cycles is increased by 8.7%.

Hence, in the present disclosure, a nano-cubic composite electrode material prepared by a self-assembling method by introducing a block polymer containing disulfide bond has a relatively large contactable surface area, thereby improving the electrical conductivity of the material, improving the specific capacity, and also improving the electrochemical performance such as the rate performance and the cycle performance, improving the initial coulombic efficiency, and achieving the effect of greatly improving the performance of a cell.

2. Compared with Comparative Example 2, Example 1 has the following advantages: (1) the discharge specific capacity is increased by 9.4%; (2) the initial coulombic efficiency is increased by 4.2%; (3) after 100 cycles, the remaining capacity is increased by 15.8%; and (4) the capacity retention rate after 100 cycles is increased by 5.8%. Hence, in the present disclosure, by introducing PDA to couple with NVP, the transmission of sodium ions in the NVP structure is facilitated, and the rate performance and cycle performance of a NVP positive electrode material can be further effectively improved.

In conclusion, the obtained electrode material not only can improve the electrical conductivity of the material, but also improve the cycle performance and rate performance of the material. This is because by introducing a nano-cubic morphology structure, which has a larger contactable surface area than that of spherical particles and a plane, and the introduced PDA generates a coupling effect with NVP, the transmission of sodium ions in the NVP structure is facilitated, the rate performance and cycle performance of the NVP positive electrode material are effectively improved, and a good specific capacity is greatly increased and optimized and the loss of first coulombic efficiency is compensated, thereby greatly improving the performance thereof.

Apparently, the described embodiments are merely examples made for clear illustration, and are not intended to limit the embodiments. For a person of ordinary skill in the art, other variations or modifications of different forms may be made on the basis of the described illustration. Herein, it is neither necessary nor possible to list all embodiments in an exhaustive manner. Moreover, obvious variations or modifications derived therefrom are still within the scope of protection of the present invention and creation.

1. A nano-cubic polyanionic electrode material for a sodium ion battery, wherein the electrode material comprising Na₃V₂(PO₄)₃@M; wherein M is a block polymer containing disulfide bond.

2. The nano-cubic polyanionic electrode material for a sodium ion battery according to claim 1, wherein the block polymer containing disulfide bond is selected from one or more of PLA-SS-PLA, mPEG-SS-PLGA, mPEG-SS-PLA, mPEG-SS-PEI, mPEG-SS-Hyaluronate, mPEG-SS-Dextran, mPEG-SS-Chitosan, PCL-SS-Dextran, PLGA-SS-Dextran, PLA-SS-Dextran, PCL-SS-PEI, PLGA-SS-PEI, PLA-SS-PEI and PTMC-SS-PTMC.

3. The nano-cubic polyanionic electrode material for a sodium ion battery according to claim 1, wherein the electrode material comprising Na₃V₂(PO₄)₃@M@N; wherein N is dopamine and/or polydopamine.

4. The nano-cubic polyanionic electrode material for a sodium ion battery according to claim 1, wherein the electrode material having at least one of the following parameters:
a) a lattice spacing of 1.05 Å to 4.9 Å;
b) a particle size D50 of 1.5 μm to 115.8 μm;
c) a specific surface area BET of 0.10 m²/g to 2.73 m²/g; and
d) a water content of 0.001 wt % to 3.56 wt %.

5. A preparation method for a nano-cubic polyanionic electrode material for a sodium ion battery, comprising the following steps:
(1) mixing a vanadium source, a sodium source and a phosphorus source uniformly, adding a block polymer containing disulfide bond, dissolving in a solvent, and stirring to obtain a gel; and
(2) dripping the gel obtained in step (1) onto the surface of a solid substrate, and performing a rotary heating under irradiation of an external light source and protection of a reducing gas, so as to obtain the nano-cubic polyanionic electrode material for a sodium ion battery.

6. The preparation method according to claim 5, wherein step (1) further comprising adding a dopamine solution and/or a polydopamine solution.

7. The preparation method according to claim 5, wherein in step (1), the vanadium source is selected from one or more of vanadium pentoxide, vanadium trioxide, ammonium metavanadate, vanadium phosphate, vanadium sulfate and vanadyl sulfate; the sodium source is selected from one or more of sodium carbonate, sodium hydroxide, sodium oxide, sodium peroxide, sodium phosphate, sodium sulfate, sodium dihydrogen phosphate, sodium dihydrogen sulfate, and sodium phenoxide; and the phosphorus source is selected from one or more of phosphate, phosphoric acid and phosphorus pentoxide.

8. The preparation method according to claim 5, wherein in step (2), at least one of the following conditions being satisfied:
1) a material of the solid substrate is selected from aluminum, copper, silicon or glass;
2) the conditions of the rotary heating including: a rotational speed of 0.1 rpm to 100 rpm, a temperature of 250° C. to 1050° C., and the time of 0.5 h to 48 h; and
3) a wavelength of the external light source of 10 nm to 1050 nm; a illumination intensity of 80 w/cm² to 240 w/cm², and a time of 0.5 h to 3 h.

9. The preparation method according to claim 5, wherein in step (2), the reducing gas at least satisfying one of the following conditions:
a) the reducing gas comprising hydrogen and an inert gas or nitrogen; the inert gas is selected from at least one of helium gas, neon gas, and argon gas;
and b) a volume percentage of hydrogen is greater than 0% and less than or equal to 20%, and a volume percentage of the inert gas is greater than or equal to 80% and less than 100%.

10. An electrode sheet, comprising the nano-cubic polyanionic electrode material for a sodium ion battery according to claim 1.

11. A sodium battery, comprising the electrode sheet of claim 10.

12. The nano-cubic polyanionic electrode material for a sodium ion battery according to claim 2, wherein the electrode material having at least one of the following parameters:
a) a lattice spacing of 1.05 Å to 4.9 Å;
b) a particle size D50 of 1.5 μm to 115.8 μm;
c) a specific surface area BET of 0.10 m²/g to 2.73 m²/g; and
d) a water content of 0.001 wt % to 3.56 wt %.

13. The nano-cubic polyanionic electrode material for a sodium ion battery according to claim 3, wherein the electrode material having at least one of the following parameters:
a) a lattice spacing of 1.05 Å to 4.9 Å;
b) a particle size D50 of 1.5 μm to 115.8 μm;
c) a specific surface area BET of 0.10 m²/g to 2.73 m²/g; and
d) a water content of 0.001 wt % to 3.56 wt %.

14. The electrode sheet according to claim 10, wherein the block polymer containing disulfide bond is selected from one or more of PLA-SS-PLA, mPEG-SS-PLGA, mPEG-SS-PLA, mPEG-SS-PEI, mPEG-SS-Hyaluronate, mPEG-SS-Dextran, mPEG-SS-Chitosan, PCL-SS-Dextran, PLGA-SS-Dextran, PLA-SS-Dextran, PCL-SS-PEI, PLGA-SS-PEI, PLA-SS-PEI and PTMC-SS-PTMC.

15. The electrode sheet according to claim 10, wherein the electrode material comprising Na₃V₂(PO₄)₃@M@N; wherein N is dopamine and/or polydopamine.

16. The electrode sheet according to claim 10, wherein the electrode material having at least one of the following parameters:
a) a lattice spacing of 1.05 Å to 4.9 Å;
b) a particle size D50 of 1.5 μm to 115.8 μm;
c) a specific surface area BET of 0.10 m²/g to 2.73 m²/g; and
d) a water content of 0.001 wt % to 3.56 wt %.

17. The preparation method according to claim 5, wherein in step (1), a molar ratio of the vanadium source, the sodium source, and the phosphorus source is 0.01-2:0.01-4:0.01-3.

18. The preparation method according to claim 5, wherein in step (1), the solvent selected from one or more of ethanol, water, acetone, methanol, toluene, pentane, ethyl acetate and diethyl ether.

19. The preparation method according to claim 18, wherein the solvent is a mixed solvent of ethanol and water, and a volume ratio of the ethanol to the water is 0.01-500:0.01-500.
